(19) United States
(12) Patent Application Publication
(10) Pub. No.: US 2005/0156358 A1
(43) Pub. Date: Jul. 21, 2005

(54) Method of making a formable hockey stick blade

(76) Inventors: Alain Bellefleur, St-Luc (CA); Win Fream, Newfields, NH (US)

Correspondence Address: Ralph A. Dowell of DOWELL & DOWELL P.C., 2111 Eisenhower Ave., Suite 406, Alexandria, VA, 22314, US

(21) Appl. No.: 10/948,548

(22) Filed: Sep. 24, 2004

(30) Foreign Application Priority Data
Jan. 15, 2004 (CA) 2,455,275

(51) Int. Cl. B29C 70/44; B29C 70/48

(52) U.S. Cl. 264/510; 264/255; 264/257; 264/236; 264/102; 264/571; 264/161; 264/322; 264/339

(57) ABSTRACT

A method of making a formable hockey stick blade comprising making a core of synthetic material; recovering the core with a fibers layer for forming a preformed blade; placing the preformed blade in a mold; injecting in the mold, at a pressure between 45 psi and 60 psi and a temperature between 350° F. and 400° F., a thermoplastic resin having a viscosity below 25 cP while maintaining a negative pressure of at least 200 mm of mercury in the mold; curing the thermoplastic resin; and removing the blade from the mold. The invention also relates to a method of selling a hockey stick blade wherein a blade is shaped in accordance to a curvature selected by a customer.

### FIELD OF THE INVENTION

The present invention relates to a method of making a formable hockey stick blade. The invention also relates to a method of selling a hockey stick blade wherein a blade is shaped in accordance to a curvature selected by a customer.

### BACKGROUND OF THE INVENTION

Typical hockey stick blades or replacement blades are generally made of a wooden core reinforced with one or more layers of synthetic material such as fiberglass, carbon fiber or graphite. The core of the blade may also be made of a synthetic material reinforced with layers of fibers material. The layers are usually made of woven filament fibers, typically soaked in a resin and glued to the surfaces of the core of the blade. Expandable fibers braids may also be used for recovering the core of the blade.

U.S. Pat. No. 6,062,996 discloses a sport implement comprising a blade structure having a core with an elongated insert and a peripheral frame. The blade structure is non-deformable at a first temperature and is formable at a second temperature that is greater that the first temperature and less than 250° F.

There is a demand for a formable hockey stick blade that has a weight, stiffness and strength adapted for high-level hockey players and can be heated and shaped repeatedly to selected curvatures.

### SUMMARY OF THE INVENTION

As embodied and broadly described herein, the invention provides a method of making a formable hockey stick blade, comprising: (a) making a core of synthetic material, the core extending along a longitudinal axis; (b) recovering the core with a fibers layer for forming a preformed blade; (c) placing the preformed blade in a mold; (d) injecting in the mold, at a pressure between 45 psi and 60 psi and a temperature between 350° F. and 400° F., a thermoplastic resin having a viscosity below 25 cP while maintaining a negative pressure of at least 200 mm of mercury in the mold; (e) curing the thermoplastic resin; and (f) removing the blade from the mold.

As embodied and broadly described herein, the invention also provides a method of selling a hockey stick blade, comprising: (a) providing to a customer a hockey stick blade that is formable between 425° F. and 500° F.; (b) providing to the customer a plurality of curvatures; (c) selecting a curvature in the plurality of curvatures; (d) placing the hockey stick blade in a oven being at a temperature of at least 300° F. during a sufficient period of time such that the blade becomes formable; and (e) shaping the blade in accordance with the selected curvature.

Other objects and features of the invention will become apparent by reference to the following description and the drawings.

### BRIEF DESCRIPTION OF THE DRAWINGS

A detailed description of the embodiments of the present invention is provided herein below, by way of example only, with reference to the accompanying drawings, in which:

FIG. 1 is a perspective view of first and second core portions used in the construction of a formable hockey stick blade according to the invention;

FIG. 2 is a perspective view of the first and second core portions of FIG. 1 with first and second fibers braids used in the construction of the blade;

FIG. 3 is a perspective view of the first and second core portions and first and second fibers braids of FIG. 2 with further third and fourth fibers braid used in the construction of the blade of FIG. 1;

FIG. 4 is a perspective view of the first and second core portions and the fibers braids of FIG. 3 with a further fifth fibers braid used in the construction of the blade of FIG. 1;

FIG. 5 is a perspective view of the blade before the molding operation;

FIG. 6 is a cross-sectional view taken along lines 6-6;

FIG. 7 is a perspective view of the preformed blade of FIG. 6 and a mold;

FIG. 8 is a perspective view of the formable hockey stick blade construed in accordance with the invention; and

FIG. 9 is a cross-sectional view taken along lines 9-9.

In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION OF THE EMBODIMENTS

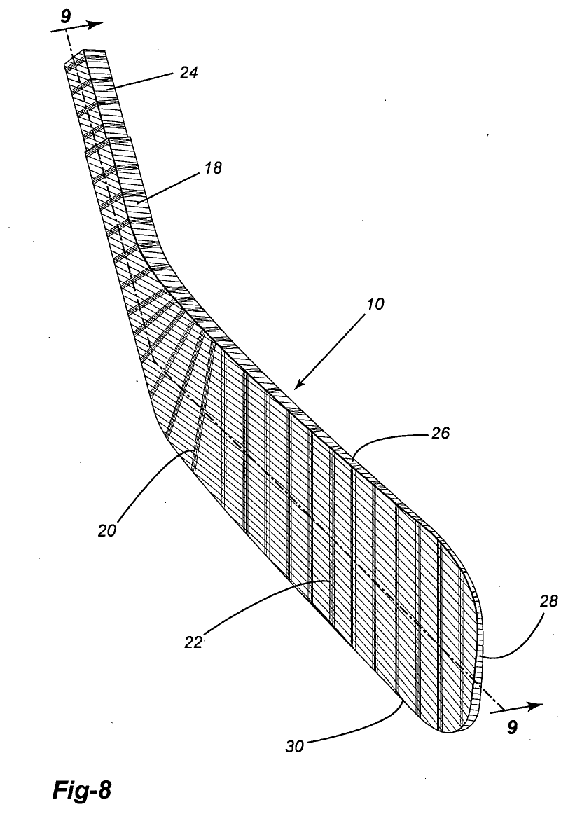

FIG. 8 illustrates a formable hockey stick blade 10 constructed in accordance with the invention. As used herein, the word “formable” means that the blade 10 can be heated and softened for shaping it to a selected curvature. The blade 10 is formable when heated to a temperature exceeding the glass transition temperature of the thermoplastic resin used for making the blade 10. The temperature increment can range between 25° F. and 50° F. above the glass temperature. The glass transition temperature of the thermoplastic resin may be around 445° F. Moreover, since a thermoplastic resin is used for making the blade 10, the blade 10 is also “reformable” i.e. it can be heated, softened and shaped a couple of times without suffering any substantial basic alteration in its properties.

The blade 10 comprises a shank 18, a heel section 20 and a blade element 22. The heel section 20 is located at the junction of the shank 18 and the blade element 22. The shank 18 comprises a tenon 24 adapted to be inserted into a hollow hockey stick shaft made of aluminum, composite or graphite. The blade element 22 comprises a top edge 26, a tip edge 28 and a bottom edge 30.

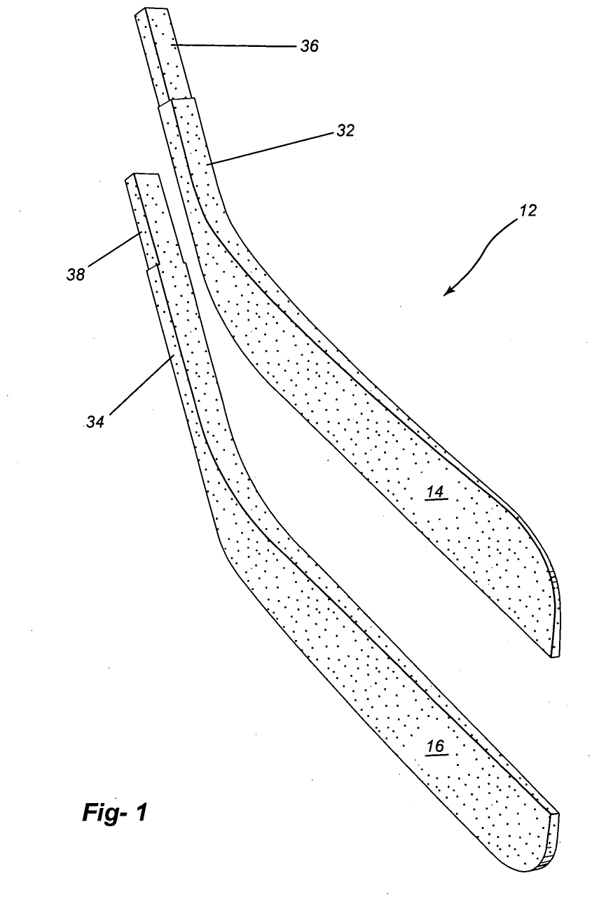

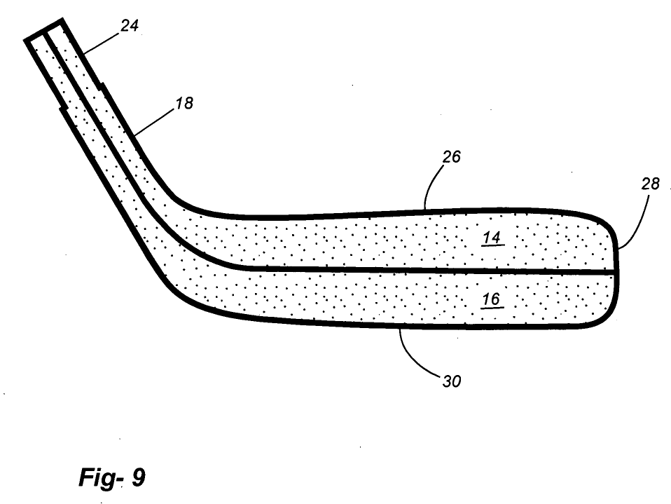

Referring to FIGS. 1 and 9, the blade 10 comprises a core 12 extending along a longitudinal axis A-A. The core 12 comprises a first portion 14 located above and aligned with a second portion 16. The first and second portions 14, 16 are dimensioned such as to have the shape of a blade when aligned with one another. The first and second portions 14, 16 are made of expandable foam such as polyurethane foam, ethylene vinyl acetate (EVA) foam, polyvinyl chloride (PVC) foam, ethylene polypropylene foam, isotropic foam or polyisocyanurate foam. For example, the first and second portions 14, 16 may be made of foam sold under the trade-mark LAST-A-FOAM, series FR-10100, which can be used at temperatures up to 350° F. and pressures up to 100 psi. The first and second portions 14, 16 may be cut from a sheet of foam. Liquid foam may also be injected in a mold in order to form the first and second portions 14, 16.

The first portion 14 may be made of foam having a density of between 6 to 12 lbs/cubic foot while the second portion 16 may be made of foam having a density of between 14 to 18 lbs/cubic foot. In one possible embodiment, the first portion 14 is made of foam having a density of 10 lbs/cubic foot and the second portion 16 is made of foam having a density of 15 lbs/cubic foot. In other possible embodiment, both first and second portions 14, 16 may be made of foam having a density of 15 lbs/cubic foot.

The first and second portions 14, 16 may further comprise respective shank portions 32, 34 defining the core of the shank 18, these shank portions 32, 34 comprising respective tenon portions 36, 38. The shank portions 32, 34 generally extend upwardly and rearwardly from the heel section 20. Hence, the core 12 comprises the first portion 14 with its shank portion 32 and the second portion 16 with its shank portion 34.

It is understood that the core may comprise first and second portions that do not comprise respective first and second shank portions. In fact, the first and second portions of the core may be confined to the blade element of the hockey stick blade (from the heel section to the tip edge) and the shank may be a separate component that is joined to the blade element. For example, the shank may be made of wood and comprises a groove in which a tongue portion provided on the blade element is inserted for joining together both components.

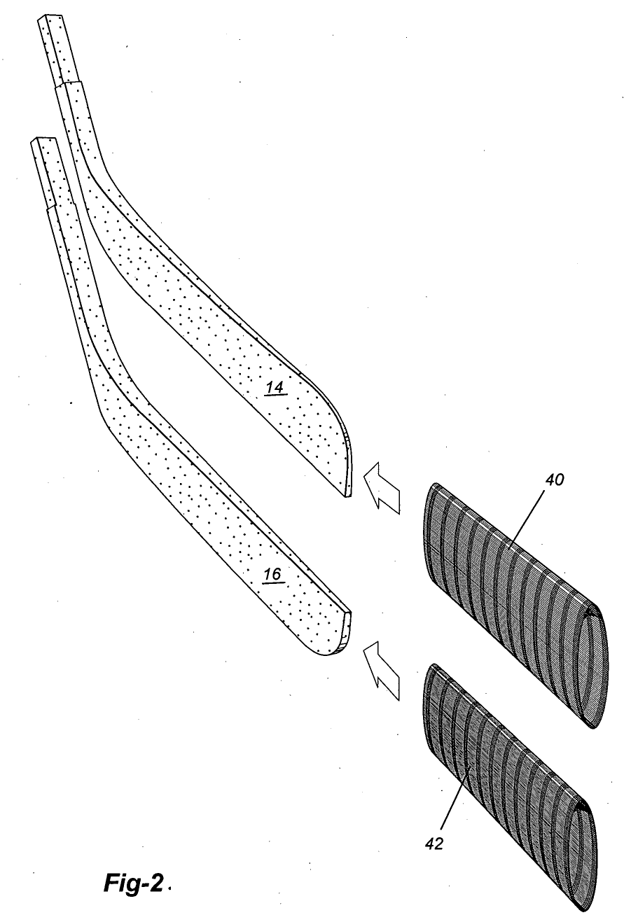

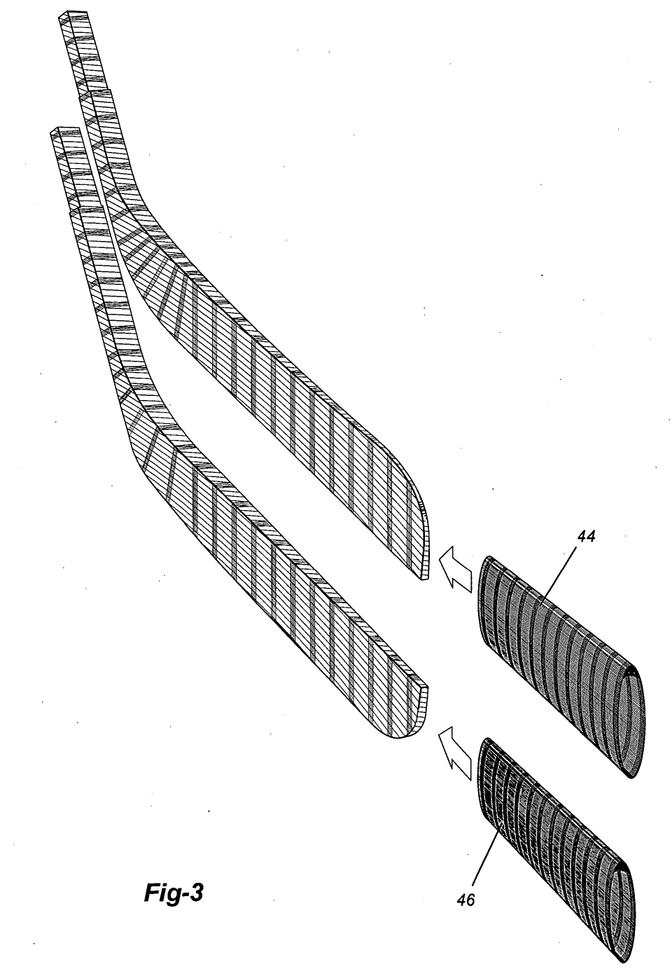

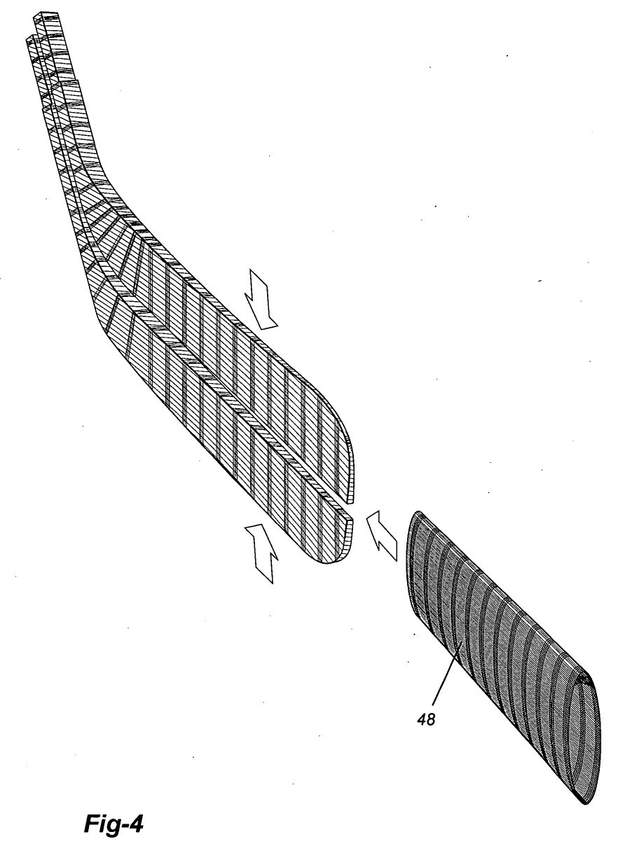

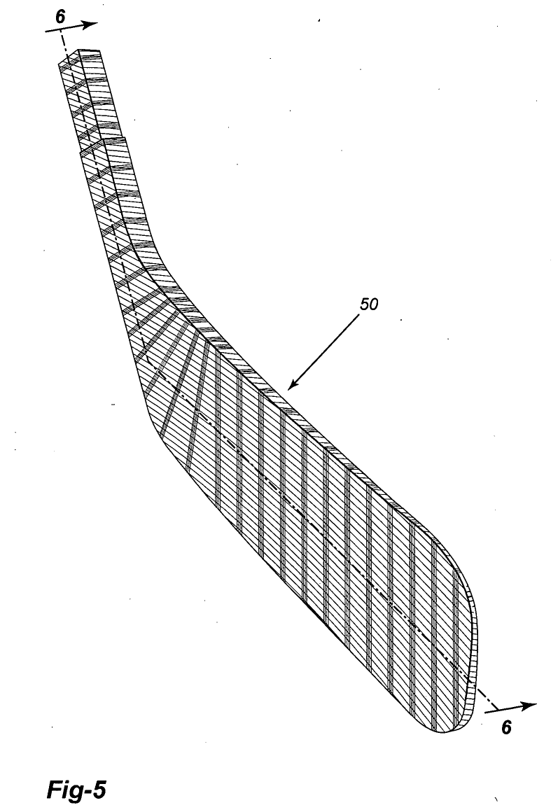

As shown in FIG. 2, a first fibers braid 40 is wrapped over the first portion 14 and a second fibers braid 42 is wrapped over the second portion 16. As shown in FIG. 3, third and fourth fibers braid 44, 46 are wrapped over the respective first and second fibers braids 40, 42 of the first and second portions 14, 16. As shown in FIG. 4, a fifth fibers braid 48 is wrapped over the third and fourth fibers braids 44, 46 of the first and second portions 14, 16 such as to realize a preformed blade 50 as shown in FIG. 5. Note that the preformed blade 50 comprises the core made of synthetic material and the fibers braids covering that core and is a “preformed” blade since it has to be placed in a mold in order to form the blade 10.

The fibers braids are expandable so as to conform to the shape of the first and second portions 14, 16 and are made of woven fibers selected from the group consisting of carbon fibers, glass fibers, KEVLAR fibers, ceramic fibers, boron fibers, quartz fibers, spectra fibers, polyester fibers and polyethylene fibers. For instance, carbon fibers braids manufactured by Eurocabon may be used. A 3K carbon fibers braid, medium weight, commercialized by A & P Technology may also be used. Moreover, the fibers braids may be made of fibers crossing at 45°. However, any other fibers crossing at between 30° and 60° may be used.

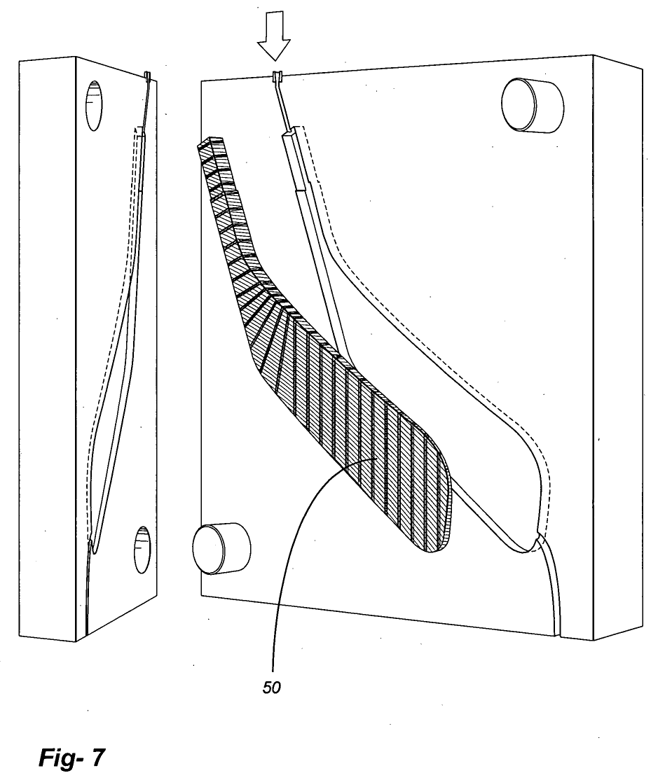

As shown in FIG. 7, the preformed blade 50 is afterwards inserted in a mold in order to manufacture the blade 10 by a resin transfer molding (RTM) process. At that point, the mold may be at a temperature of about 375° F. It is understood that the mold may be heated before or after the introduction of the preformed blade 50 in the mold or it may remain at a steady temperature during the entire process. Afterwards, a suitable thermoplastic resin is then injected into the mold to impregnate the expandable fibers braids. Note that the mold is at a temperature of about 375° at the thermoplastic resin injection stage. The injection pressure of the thermoplastic resin may be between 45 psi and 60 psi and the resin may be at a temperature between 350° F. and 400° F. The thermoplastic resin has a viscosity below 25 cP. For example, the CBT thermoplastic resin commercialized by Cyclics Corporation can be used. A vacuum pump is mounted on the mold for easing the flow of resin through the fibers braids. In fact, during injection, the pump creates a negative pressure of at least 200 mm of mercury (3.87 psi). Once the injection is completed, the mold remains at a temperate of at least 375° F. for at least 8 minutes in order to cure the thermoplastic resin and air may be injected in the mold at a pressure of at least 40 psi during the curing stage. When the resin is cured, the mold is opened and the blade 10 is removed from the mold. Note that the blade 10 has the general shape of a straight hockey stick blade.

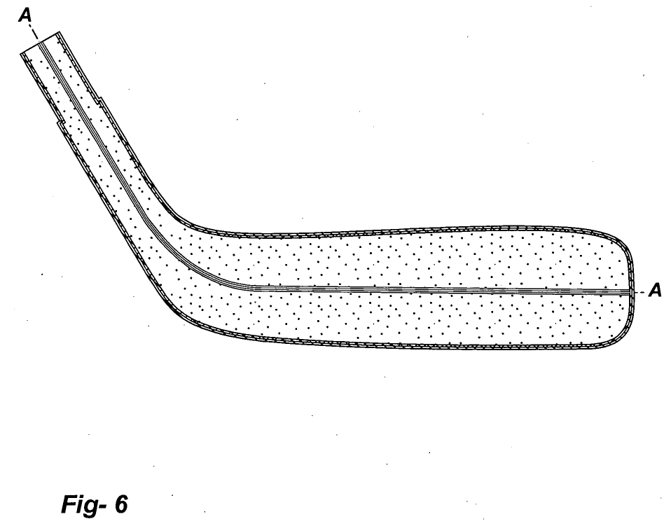

FIG. 6 shows a cross section view of the preformed blade 50 for illustrating the fiber braids before the molding process. In fact, once the thermoplastic resin is injected in the fiber braids and the fiber-resin matrix is cured (see large lines on FIG. 9), the blade 10 comprises an interface between the first and second portions 14, 16, this interface comprising fibers oriented transversely relative to the longitudinal axis A-A. The fiber-resin matrix of the edges 26, 28, 30 (see large lines on FIG. 9) may also comprise fibers oriented transversely relative to the longitudinal axis A-A.

The blade 10 is a formable straight blade and it is therefore possible to supply this blade to stores that will then tailor the blade 10 by heating and applying pressure to shape it according to a curvature selected by a customer. Hence, the present invention also covers the following method of selling a hockey stick blade: providing to a customer a hockey stick blade that is formable between 425° F. and 500° F.; providing a plurality of curvatures to the customer; selecting a curvature in the plurality of curvatures; placing the hockey stick blade in a oven being at a temperature of at least 300° F. during a sufficient period of time such that the blade becomes formable; and shaping the blade in accordance with the selected curvature.

If the blade is formable between 425° F. and 500° F., as the above described blade 10, the blade will then be placed in an oven being at a temperature between 300° F. and 445° F. for a sufficient period of time such that the blade becomes formable. For example, with an infrared oven of 3 to 6 Watts/square inches, this period of time may be between 5 and 8 minutes, and with an infrared oven of 15 to 20 Watts/square inches, this period of time may be between 1 and 3 minutes. It is understood that the oven must be at a temperature that allows the formable blade to reach a temperature higher than the glass transition temperature of the thermoplastic resin. In this regard, note that the glass transition temperature of the thermoplastic resin used in the blade may be around 445° F. to 495° F.

Once the formable blade reaches a temperature wherein it becomes formable, the blade is rapidly put in a shaping station such that it may be shaped in accordance with the selected curvature. Pressure in a range of 10 psi to 40 psi may be applied on the blade for shaping it to the selected curvature. Alternatively, a vacuum bag form may be use for imparting the curvature to the blade. Once the blade is shaped, it remains in the shaping station such that the temperature of the blade continues to decrease at a rate between 75° F. and 125° F. per minute until it reaches the room temperature.

The above description of the embodiments should not be interpreted in a limiting manner since other variations, modifications and refinements are possible within the spirit and scope of the present invention. The scope of the invention is defined in the appended claims and their equivalents.

1. A method of making a formable hockey stick blade, comprising:
(a) making a core of synthetic material, the core extending along a longitudinal axis;
(b) recovering the core with a fibers layer for forming a preformed blade;
(c) placing the preformed blade in a mold;
(d) injecting in the mold, at a pressure between 45 psi and 60 psi and a temperature between 350° F. and 400° F., a thermoplastic resin having a viscosity below 25 cP while maintaining a negative pressure of at least 200 mm of mercury in the mold;
(e) curing the thermoplastic resin; and
(f) removing the blade from the mold.

2. A method as defined in claim 1, wherein the temperature of the mold is at least 375° F. during step (d).

3. A method as defined in claim 2, wherein the temperature of the mold is at least 375° F. during steps (c) to (e).

4. A method as defined in claim 3, wherein step (e) comprises maintaining the mold at a temperature of at least 375° F. for at least 8 minutes and injecting air in the mold at a pressure of at least 40 psi.

5. A method as defined in claim 3, wherein the core made of synthetic material is selected in the group consisting polyurethane foam, ethylene vinyl acetate (EVA) foam, polyvinyl chloride (PVC) foam, ethylene polypropylene foam, isotropic foam and polyisocyanurate foam.

6. A method as defined in claim 5, wherein step (a) comprises cutting first and second portions such that the first portion comprises a bottom surface following the longitudinal axis and the second portion comprises a top surface following the longitudinal axis, the first and second portion forming the core once the first portion is aligned with and placed over the second portion.

7. A method as defined in claim 6, wherein step (b) comprises wrapping the first portion in a first fiber braid and the second portion in a second fiber braid, the first and second fibers braid comprising fibers selected from the group consisting of carbon fibers, glass fibers, KEVLAR fibers, ceramic fibers, boron fibers, quartz fibers, spectra fibers, polyester fibers and polyethylene fibers.

8. A method as defined in claim 7, wherein step (b) further comprises wrapping the first and second portions and first and second fiber braids in respective third and fourth fiber braids that comprise fibers selected from the group consisting of carbon fibers, glass fibers, KEVLAR fibers, ceramic fibers, boron fibers, quartz fibers, spectra fibers, polyester fibers and polyethylene fibers.

9. A method as defined in claim 8, wherein step (b) further comprises wrapping the first and second portions and first, second, third and fourth fiber braids in a fifth fiber braid that comprises fibers selected from the group consisting of carbon fibers, glass fibers, KEVLAR fibers, ceramic fibers, boron fibers, quartz fibers, spectra fibers, polyester fibers and polyethylene fibers.

10. A method as defined in claim 9 further comprising trimming said formable hockey stick blade.

11. A method of selling a hockey stick blade, comprising:
(a) providing to a customer a hockey stick blade that is formable between 425° F. and 500° F.;
(b) providing to the customer a plurality of curvatures;
(c) selecting a curvature in the plurality of curvatures;
(d) placing the hockey stick blade in a oven being at a temperature of at least 300° F. during a sufficient period of time such that the blade becomes formable; and
(e) shaping the blade in accordance with the selected curvature.

12. A method as defined in claim 11, wherein the blade is formable between 450° F. and 500° F.

13. A method as defined in claim 12, wherein the oven is at a temperature of 400° F. to 450° F.

14. A method as defined in claim 13, wherein, during step (d), the blade remains in the oven for a period of time between 1 minute and 3 minutes.

15. A method as defined in claim 13, wherein, during step (d), the blade remains in the oven for a period of time between 5 minute and 8 minutes

16. A method as defined in claim 13 further comprising cooling the blade to the room temperature at a rate between 75° F. and 125° F. per minute.

17. A method as defined in claim 13 further comprising applying on the blade a pressure between 10 psi and 40 psi during step (e).
